(19) United States
(12) Patent Application Publication
(10) Pub. No.: US 2016/0188302 A1
(43) Pub. Date: Jun. 30, 2016

(54) AUTOMATIC GENERATION OF METADATA-BASED CROSS-PLATFORM MOBILE APPLICATIONS

(71) Applicants: Randy Fredrick, Steamboat Springs, CO (US); David Cox, Ivins, UT (US); David Brandow, Guelph (CA); Yunjiao Xue, Waterloo (CA)

(72) Inventors: Randy Fredrick, Steamboat Springs, CO (US); David Cox, Ivins, UT (US); David Brandow, Guelph (CA); Yunjiao Xue, Waterloo (CA)

(21) Appl. No.: 14/586,593

(22) Filed: Dec. 30, 2014

(51) Int. Cl. G06F 9/44; G06F 3/0482; G06F 17/30; G06F 3/0484

(52) U.S. Cl. CPC G06F 8/34; G06F 3/04842; G06F 3/0482; G06F 17/30525

(57) ABSTRACT

Techniques of generating metadata-based cross-platform mobile applications through user selection are disclosed. An application can be generated by receiving a selection of a data source having a set of data objects, a selection of a data object to which data set from the data source is to be populated, selections of operations to be performed on the data object, a selection of a platform, and the selection of the data object. One or more metadata elements can be generated defining interactions with the data object of the data source and the interactive object on the platforms. The application can be generated from the one or more metadata elements.

### TECHNICAL FIELD

The present application relates generally to the technical field of data processing and, in various embodiments, to methods and systems of generating metadata-based applications from selections of a user.

### BACKGROUND

Competing manufacturers, developers, and service providers offer varying hardware and software that either makes up all or part of a mobile device or a desktop device. Software applications can consist of instructions that can be executed within an operating system stored on the mobile device or the desktop device. These manufacturers, developers, and service providers offer dissimilar and sometimes incompatible device platforms, environments, and programs or applications. Developing applications for mobile and desktop devices with differing operating systems has typically used varying programming languages, programming environments, application programming interfaces, development styles, and development requirements.

Development challenges for developing cross-platform applications involve efficiencies for creating applications between differing mobile devices and desktop devices. Developing metadata-based applications can include challenges in writing metadata definitions, similar to that of writing processor executable instructions for software applications. Systems and methods that guide programmers or developers through developing cross-platform applications often require the developer or programmer to have substantial expertise and to develop sections of code/metadata or require customization of code/metadata elements in order to conform those code/metadata elements to the application being developed.

### BRIEF DESCRIPTION OF THE DRAWINGS

Some embodiments of the present disclosure are illustrated by way of example and not limitation in the figures of the accompanying drawings, in which like reference numbers indicate similar elements, and in which:

FIG. 1 is a network diagram illustrating a client-server system, in accordance with some example embodiments;

FIG. 2 is a block diagram illustrating enterprise applications and services in an enterprise application platform, in accordance with some example embodiments;

FIG. 3 is a block diagram of a development module, in accordance with some example embodiments, of the enterprise application platform of FIG. 2;

FIG. 4 is a flowchart illustrating a method, in accordance with some example embodiments, of generating one or more metadata elements, from a set of selections, configured to interact with an application;

FIG. 5 is a flowchart illustrating a method, in accordance with some example embodiments, of generating one or more metadata elements, from a set of selections, configured to interact with an application;

FIG. 6 is a flowchart illustrating a method, in accordance with some example embodiments, of generating one or more metadata elements, from a set of selections, configured to interact with an application;

FIG. 7 is a block diagram illustrating a mobile device, in accordance with some example embodiments; and

FIG. 8 is a block diagram of an example computer system on which methodologies described herein can be executed, in accordance with some example embodiments.

### DETAILED DESCRIPTION

Example methods and systems of automatically generating applications from metadata and user selections are disclosed. Applications generated from metadata can be thought of as metadata-based applications. These metadata-driven applications can contain metadata instead of instructions. Metadata can be more descriptive than instructive, and can specify what components an application has, what the application looks like (e.g., when presented to a user on a monitor or a mobile device), how the application should behave (e.g., responding to input or selections from a user or a device), as well specifying as other elements or aspects of the application, regardless of whether those elements or aspects are apparent to a user. Metadata can take any form, but, as will be described below, can be in the form of Extensible Markup Language (XML). In at least some example embodiments, metadata-based applications can depend on another executable application to interpret the metadata of the metadata-driven application. The executable application, interpreting the metadata can enable the metadata-based application to run or otherwise be executed on a device.

The metadata-based applications may be generated by a computer system without the user directly writing code or instruction elements for the application. The user may select a data source, a data object, a set of properties of the data object, a set of operations to be performed on the data object, a set of platforms (such as iPhone, iPad, Android, Windows, WinCE, etc, and a set of user interface screens, with the system generating one or more metadata elements based on the selections received from the user. Metadata elements for a business object will be generated from the selected data object as well as the selected properties. The system may then generate a metadata-based application which can be interpreted by an application on a device comprised of executable instructions capable of interpreting the metadata elements. In the following description, for purposes of explanation, numerous specific details are set forth in order to provide a thorough understanding of example embodiments. It will be evident, however, to one skilled in the art that the present embodiments can be practiced without these specific details.

In some example embodiments, a method is performed by receiving a selection of a data source having a set of data objects, receiving a selection of a data object, receiving a selection of a set of operations, receiving a selection of a set of platforms, and receiving a set of user interface screens. One or more metadata elements are generated by a machine and the elements determine how an application will look and behave.

In some example embodiments, the method further includes defining an order of generating the one or more metadata elements. In some embodiments, the machine may define the order of generating the metadata elements based on a predetermined set of rules.

The method can include receiving one or more selections of user controls that enable a user to interact with the selected data object. The machine may generate one or more metadata elements corresponding to the one or more selected user controls and include the generated one or more metadata elements in the application.

The method may further include receiving one or more selections of a set of user interface options and generating one or more metadata elements corresponding to the one or more selected user interface options. The machine may then include the metadata element for the selected user interface option in the application.

In some example embodiments, the method includes creating relationships between one or more properties of the selected data object and one or more properties of the business object to be generated. The machine may additionally generate relationships between data retrieved from the data source and the business object. The machine may generate one or more metadata elements corresponding to the relationships and include that metadata element in the application.

The method may further include the machine determining at least one field of data and at least one property of data within the set of data. The machine may present the at least one field of data and the at least one property of data to a user, receive a selection of one or more of the at least one field of data and the at least one property of data, and generate one or more metadata elements corresponding to the selected one or more fields of data and properties of data. The machine may then include the one or more metadata elements in the application.

The method can include presenting one or more user interface screens to a user and receiving a selection of the one or more user interface screens. The system generates one or more metadata elements corresponding to the selected one or more user interface screens and may include the generated metadata elements in the application.

In some example embodiments, a system is presented as comprising a receiver module and a generation module. The receiver module and generation module comprising a hardware processor, in at least some embodiments. The receiver module can be configured to receive a selection of a data source having a set of data objects, receive a data object, receive a selection of a set of properties of the data object, receive a selection of operations to be performed on the data object, receive a selection of a set of platforms, and receive a selection of a set of user interface screens. The generation module can be configured to generate one or more metadata elements, based on the received selections. The receiver module and the generation module are configured to interact with the data set of the selected data source and the selected data object on the selected platform. The generation module then generates an application from the one or more metadata elements, in some example embodiments.

The system can be provided with a receiver module, an element generation module, and an application generation module. The receiver module may receive the selection of the data source, the data object, the set of properties, the set of operations, the set of platforms, and the set of user interface screens. The element generation may generate the one or more metadata elements, and the application generation module may receive the one or more metadata elements and generate an application.

In some example embodiments, a non-transitory machine-readable storage medium is presented. The non-transitory machine-readable storage medium tangibly embodies a set of instructions that, when executed by at least one processor, causes the at least one processor to perform a set of operations. The set of operations includes receiving a selection of a data source having a set of data objects, receiving a selection of a data object, receiving a select of a set of properties, receiving a selection of a set of operations, receiving a selection of a set of platforms, and receiving a selection of a set of user interface screens. The instructions further cause the at least one processor to generate one or more metadata elements defining interactions with the selected data object on the selected platforms, based on the received selections. The instructions then cause the processor to generate an application from the one or more metadata elements.

The methods or embodiments disclosed herein may be implemented as a computer system having one or more modules (e.g., hardware modules or software modules). Such modules may be executed by one or more processors of the computer system. In some embodiments, a non-transitory machine-readable storage device can store a set of instructions that, when executed by at least one processor, causes the at least one processor to perform the operations and method steps discussed within the present disclosure.

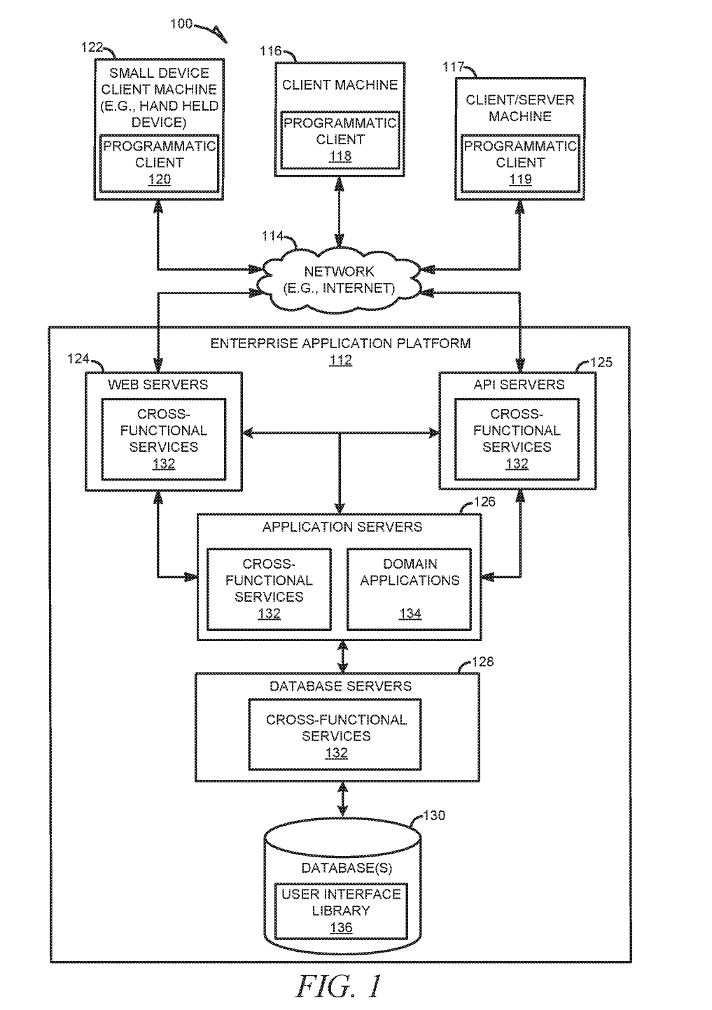

FIG. 1 is a network diagram illustrating a client-server system 100, in accordance with an example embodiment. A platform (e.g., machines and software), in the example form of an enterprise application platform 112, provides server-side functionality, via a network 114 (e.g., the Internet) to one or more clients. FIG. 1 illustrates, for example, a client machine 116 with programmatic client 118 (e.g., a browser), a small device client machine 122 with programmatic client 120 (e.g., a browser), and a client/server machine 117 with a programmatic client 119.

Turning specifically to the example enterprise application platform 112, web servers 124 and Application Program Interface (API) servers 125 can be coupled to, and provide web and programmatic interfaces to, application servers 126. The application servers 126 can be, in turn, coupled to one or more database servers 128 that facilitate access to one or more databases 130. Cross-functional services 132 can include relational database modules to provide support services for access to the database(s) 130, which includes a user interface library 136. The web servers 124, API servers 125, application servers 126, and database servers 128 can host cross-functional services 132. The application servers 126 can further host domain applications 134.

The cross-functional services 132 provide services to users and processes that utilize the enterprise application platform 112. For instance, the cross-functional services 132 can provide portal services (e.g., web services), database services, and connectivity to the domain applications 134 for users that operate the client machine 116, the client/server machine 117 and the small device client machine 122. In addition, the cross-functional services 132 can provide an environment for delivering enhancements to existing applications and for integrating third-party and legacy applications with existing cross-functional services 132 and domain applications 134. Further, while the system 100 shown in FIG. 1 employs a client-server architecture, the embodiments of the present disclosure are, of course, not limited to such an architecture, and could equally well find application in a distributed, or peer-to-peer, architecture system.

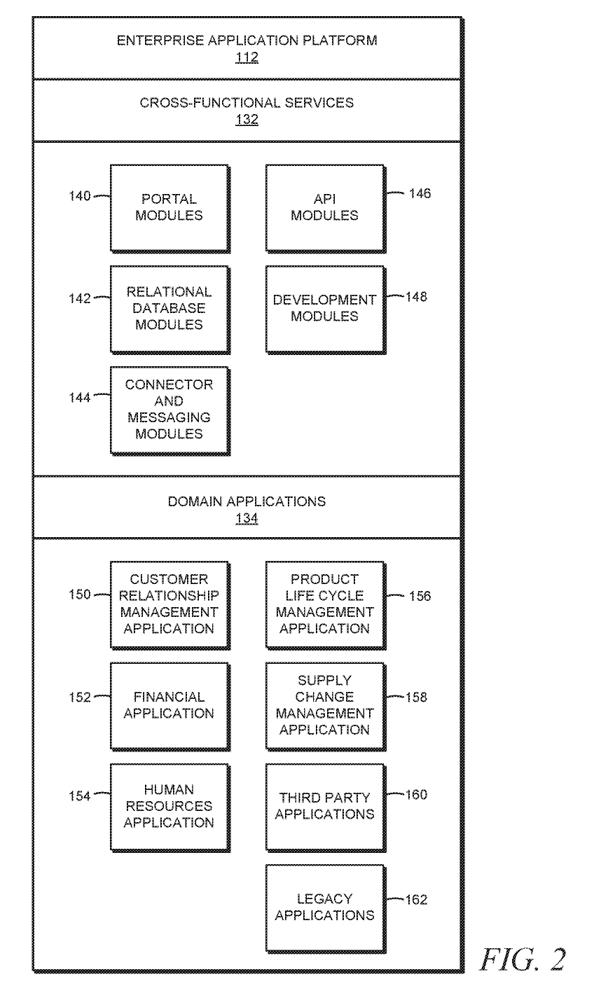

The enterprise application platform 112 can implement partition level operations with concurrent activities. For example, the enterprise application platform 112 can implement a partition level lock or a schema lock mechanism, manage activity logs for concurrent activity, generate and maintain statistics at the partition level, and efficiently build global indexes. In some embodiments, the enterprise application platform 112 can configured to use metadata, functioning as definitions for the activities, logs, and mechanisms described herein. The metadata, in some embodiments, can be encoded in XML. The enterprise application platform 112 is described in greater detail below in conjunction with FIG. 2.

FIG. 2 is a block diagram illustrating enterprise applications and services in an enterprise application platform 112, in accordance with an example embodiment. The enterprise application platform 112 can include cross-functional services 132 and domain applications 134. The cross-functional services 132 can include portal modules 140, relational database modules 142, connector and messaging modules 144, API modules 146, and development modules 148.

The portal modules 140 can enable a single point of access to other cross-functional services 132 and domain applications 134 for the client machine 116, the small device client machine 122, and the client/server machine 117. The portal modules 140 can be utilized to process, author, and maintain web pages that present content (e.g., user interface elements and navigational controls) to the user. In addition, the portal modules 140 can enable user roles, a construct that associates a role with a specialized environment that is utilized by a user to execute tasks, utilize services, and exchange information with other users within a defined scope. For example, the role can determine the content that is available to the user and the activities that the user can perform. The portal modules 140 include a generation module, a communication module, a receiving module and a regenerating module. In addition the portal modules 140 can comply with web services standards and/or utilize a variety of Internet technologies including Java, J2EE, SAP's Advanced Business Application Programming Language (ABAP) and Web Dynpro, XML, JCA, JAAS, X.509, LDAP, WSDL, WSRR, SOAP, UDDI and Microsoft .NET.

The relational database modules 142 can provide support services for access to the database(s) 130, which includes a user interface library 136. The relational database modules 142 can provide support for object relational mapping, database independence, and distributed computing. The relational database modules 142 can be utilized to add, delete, update, and manage database elements. In addition, the relational database modules 142 can comply with database standards and/or utilize a variety of database technologies including SQL, SQLDBC, Oracle, MySQL, Unicode, JDBC, or the like.

The connector and messaging modules 144 can enable communication across different types of messaging systems that are utilized by the cross-functional services 132 and the domain applications 134 by providing a common messaging application processing interface. The connector and messaging modules 144 can enable asynchronous communication on the enterprise application platform 112.

The API modules 146 can enable the development of service-based applications by exposing an interface to existing and new applications as services. Repositories can be included in the platform as a central place to find available services when building applications.

The development modules 148 can provide a development environment for the addition, integration, updating, and extension of software components on the enterprise application platform 112 without impacting existing cross-functional services 132 and domain applications 134. In some embodiments, some of the development modules 148 can provide a development environment for generating applications based on user selections and generation of metadata elements based on the user selections.

Turning to the domain applications 134, a customer relationship management application 150 can enable access to and facilitate collecting and storing of relevant personalized information from multiple data sources and business processes. Enterprise personnel that are tasked with developing a buyer into a long-term customer can utilize the customer relationship management applications 150 to provide assistance to the buyer throughout a customer engagement cycle.

Enterprise personnel can utilize financial applications 152 and business processes to track and control financial transactions within the enterprise application platform 112. The financial applications 152 can facilitate the execution of operational, analytical, and collaborative tasks that are associated with financial management. Specifically, the financial applications 152 can enable the performance of tasks related to financial accountability, planning, forecasting, and managing the cost of finance.

Human resources applications 154 can be utilized by enterprise personnel and business processes to manage, deploy, and track enterprise personnel. Specifically, the human resources applications 154 can enable the analysis of human resources issues and facilitate human resources decisions based on real time information.

Product life cycle management applications 156 can enable the management of a product throughout the life cycle of the product. For example, the product life cycle management applications 156 can enable collaborative engineering, custom product development, project management, asset management, and quality management among business partners.

Supply chain management applications 158 can enable monitoring of performances that are observed in supply chains. The supply chain management applications 158 can facilitate adherence to production plans and on-time delivery of products and services.

Third-party applications 160, as well as legacy applications 162, can be integrated with domain applications 134 and utilize cross-functional services 132 on the enterprise application platform 112.

In some example embodiments, the financial applications 152, the human resources applications 154, the product life cycle management applications 156, the supply chain management applications 158, or third-party applications 160 can have one or more back ends to data sources. For example the applications can have connections to databases, web services, OData services, or other forms that can provide data to and receive data from the applications.

The applications can contain business functionality modules programmed to perform specific functions. Each of the business functionality modules can be associated with one or more business objects, described in more detail below, having one or more properties. The business functionality modules can perform functions such as fetch operations to load data from data sources, transaction operations to change data in the data sources, action steps to perform other specified operations, and display operations including one or more screen sets.

The screen sets of the display operations can support one or more platforms. Further the display operations can render screens for display to a user of a client device, where the screens have one or more fields to display data or accept user input. The screens can additionally be displayed with one or more buttons to trigger actions. Each button can be associated with an action to perform one of the specified actions, described herein, or other suitable actions.

In some embodiments, one or more of the financial applications 152, the human resources applications 154, the product life cycle management applications 156, the supply chain management applications 158, or other applications of the enterprise application platform 112 can be configured to run in a client application on a client device, as native to an operating system associated with that client device. In some embodiments, a client application can act as a shell, containing no business logic when initially placed within memory of the client device. The shell application can load and interpret a metadata-based application, described herein. For example, the shell application can load and interpret application definitions, metadata of the metadata-based application, and render screens on the client device, perform actions, or otherwise function as a cohesive application. A user of the client device and other devices associated or in communication with the client device can thereby interact with the metadata-based application in the same manner as interacting with an application containing processor executable instructions.

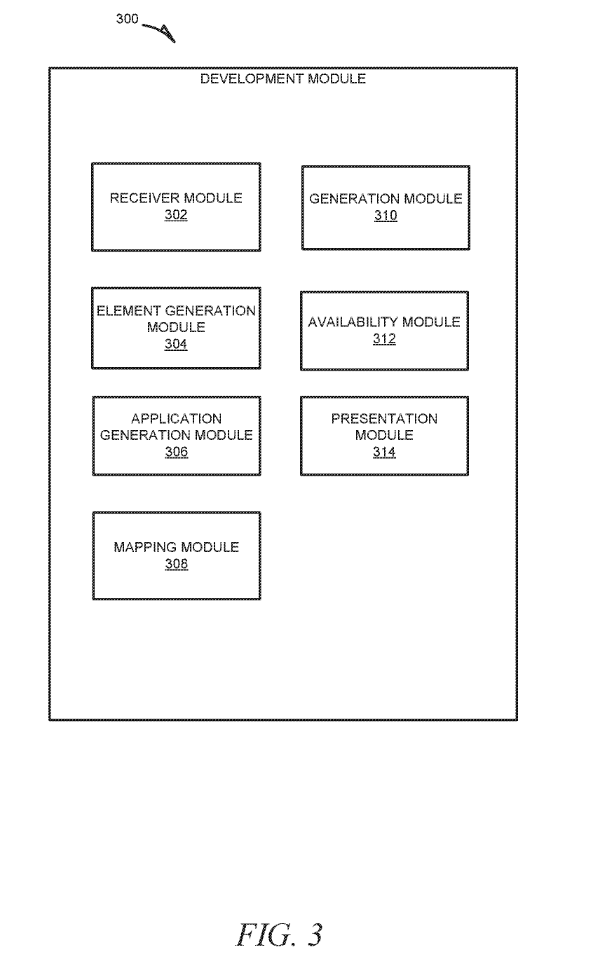

FIG. 3 is a block diagram of a development module 300, according to some example embodiments, of generating one or more metadata elements, from a set of selections, for an application. For instance, the application can perform one or more tasks, render one or more screen, or the like based on the one or more metadata elements which can inform operations performed by the application. Once the one or more metadata elements have been generated, the development module, through one or more modules contained therein can include the one or more metadata elements packaged along with the application into a single file.

The development module 300 can be similar to the development modules 148 and can include a receiver module 302, an element generation module 304, and an application generation module 306, a mapping module 308, a generation module 310, an availability module 312, and a presentation module 314. The development module 300 can also include additional modules that perform varying functions or operations relating to the methods disclosed below. The receiver module 302 may receive user inputs relating to a data source, a data object, and a set of platforms, for example. The element generation module 304 can generate metadata elements based on the user inputs received by the receiver module 302. The application generation module 306 may generate an application from the metadata elements generated by the element generation module 304.

The development module 300 can enable generation of metadata definitions for metadata-based applications. For example the development module 300 can enable generation of metadata definitions encoded as XML. In some example embodiments, the development module 300, through the modules included therein, can provide an integrated development environment presented on a graphical user interface to design application components, such as processes to be performed by an application, and configure properties of those components. After metadata definitions are designed or generated, the development module 300 can export the metadata definitions for the application components to be executed in conjunction with other applications or a shell application.

In some example embodiments, the generation module 310 includes one or both of the element generation module 304 and the application generation module 306, as well as other functionality described below. The availability module 312 can determine the availability of a connection to a data source and the readiness or availability of the current project. The presentation module 314 can present various aspects of the enterprise application program 112 for display on a user interface of a user device, such as presenting aspects via a monitor to a user. In some embodiments, the presentation module 314 can cause presentation of one or more screens and/or prompts configured to enable the user to perform selections configured to enable one or more of the generation module 310, the element generation module 304, and the application generation module 306 to generate one or more metadata elements.

The receiver module 302, the element generation module 304, and the application generation module 306, the mapping module 308, the generation module 310, the availability module 312, and the presentation module 314 may be implemented as software modules, hardware modules, or a combination of hardware and software modules, as will be explained in greater detail below, with respect to the description of modules, components, and logic. For example, at least a portion of any of the receiver module 302, the element generation module 304, and the application generation module 306, the mapping module 308, the generation module 310, the availability module 312, and the presentation module 314 can be at least partially implemented as including the components discussed below with respect to the description of modules.

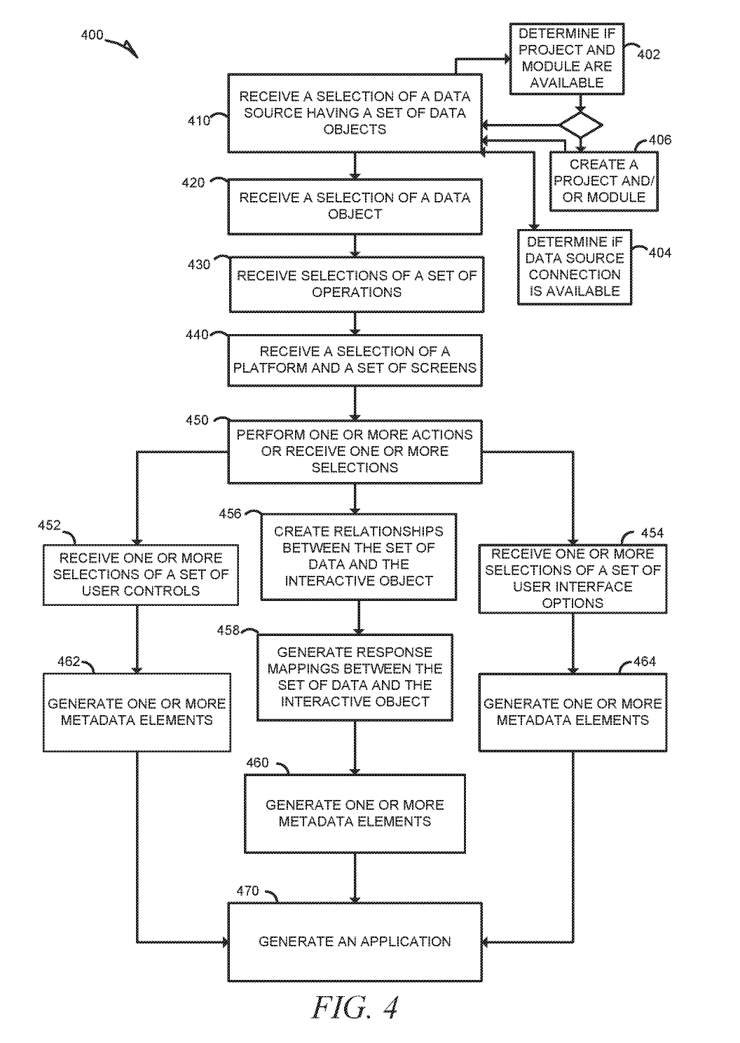

FIG. 4 is a flow chart illustrating a method 400, according to an example embodiment, of generating one or more metadata elements, from a set of selections, for an application. The method 400 may comprise operations 410, 420, 430, 440, and 450. Although operations of the method 400 may be performed on the enterprise application platform 112, the client machine 116, the client/server machine 117, a mobile device, or combinations thereof, for the sake of clarity, the method 400 will be described with reference to the enterprise application platform 112.

The operations of the method 400 can enable an automated or semi-automated generation of metadata elements, forming a metadata-based application or a metadata definition file or set, by receiving input from a user and performing one or more defined operations on the input. For example, the operations of the method 400 can create metadata elements, defining functionality of an application, for data source connection (e.g., to create business objects, transactions, and steps), fetch operations (e.g., operations capable of loading data of a business object), and display operations (e.g., generating screen sets for displaying, creating, updating, and deleting data). The method 400 can enable these operations by generating metadata elements based on receiving selections for the data source, a data object, a set of properties, a set of operations (e.g., transactions treated as operations on a selected data object), a set of platforms, and a set of screens. In some example embodiments, the resulting metadata elements, executed in conjunction with a shell application, cause the shell application to load and render an application capable of presenting a user of the application with screens, fields, buttons, and related operations enabling the user to review, create, update, and delete data for the selected data source.

In operation 410, the enterprise application platform 112 receives a selection of a data source having a set of data objects. In some example embodiments, the receiver module 302 of the enterprise application platform 112 may receive the selection of the data source. The data source may be a service, a database, a repository, a file system, or any other data source connected to a network. For example, the data source may be an OData service, an SQL database, a Java class, a representational state transfer web service, or any other suitable data source containing a set of data objects from which data may be retrieved. A data object can be a data structure such as a table, an OData entity, or a Java object.

In some example embodiments, when the enterprise application platform 112 receives a selection of the data source, the enterprise application platform 112 can generate a common gateway interface argument based on the selected data source connection. The enterprise application platform 112 may also create an encrypted authorization header based on an identity of the user and a password associated with the data source connection. In some embodiments, the enterprise application platform 112 can also fill a base XPath for response mapping.

In operation 420, the enterprise application platform 112 receives a selection of a data object of the set of data objects to which data from the data source is to be populated. For example, the receiver module 302 can receive the selection of the data object after the enterprise application platform 112 presents the set of data objects to a user for selection. In the above-referenced example, the selected data object can be one of data objects of the data source. The set of data objects can be representative of a set of interactive objects (e.g., business object) to be generated upon completion of the method 400, based on additional user selections. The interactive objects may be a model of real world entities modeled as objects in an information system. In some embodiments, the interactive object may model a business object (e.g., SAP business objects, etc.), a purchase order, purchase items, invoices, inventory statements, or other business objects. In some embodiments, the business objects may be derived from a business object template by projections and business objects built on such projections. The business object template may contain a superset of metadata from which business objects useful for various business scenarios and processes can be characterized.

In some example embodiments, in operation 430, the enterprise application platform 112 receives one or more selections of a set of operations to be performed on the data object. For example, the receiver module 302 can receive the one or more selections of the set of operations

In operation 440, the enterprise application platform 112 receives a selection of a set of platforms. Prior to operation 440, the enterprise application platform 112 can cause presentation of a set of platforms for selection by the user, such that in operation 440 the enterprise application platform may then receive the platform selection via the receiver module 302. A platform may comprise a computer system and a set of processor executable instructions stored in a non-transitory machine-readable storage medium of the computer system capable of translating the aforementioned metadata elements into processor executable instructions. The set of processor executable instructions may comprise an operating system for the computer system, a mobile device (e.g., a smart phone, a tablet, a laptop computer), or the like, along with an application running on that operating system which translates the aforementioned metadata elements into processor executable instructions. For example, a platform may be based on operating systems such as the iOS (operating system for iPhone® and iPad® from Apple®), Mac OS®, Android™, WINDOWS® Phone operating systems, WINDOWS® operating systems, and others.

In performing the operation 440, upon receiving a selection of a platform, the enterprise application platform 112 can receive one or more selections of screens from a set of screens. The set of screens can include a list screen, a detail screen for the list screen, a screen set of an add operation and an edit operation. The list screen can contain one or more interactive elements that present data of the selected object. The detail screen can provide details or additional information relating to one or more element shown on the list screen. The screen set for an add operation and an edit operation may enable adding a new object instance or editing an existing object instance.

On the list screen, the enterprise application platform 112 may cause presentation of a set of interactive elements. For example, the interactive elements may be selectable to show details of a selected object instance, to delete a selected object instance, to open the screen for the add operation, to open the screen for the edit operation, or to perform a transmission function.

In operation 450, based on the selection of the data object, the enterprise application platform may perform one or more actions or receive one or more additional selections. For example, the method 400 may further comprise operation 452, in which, the enterprise application platform 112 receives one or more selections of a set of user controls configured to enable a user to interact with the selected interactive object representative of the selected data object. One or more metadata elements include instructions, in the form of one or more selected user controls that may cause a processor of a device to perform operations of create, read, update, and delete data of the selected data object. The enterprise application platform 112 can receive the selection of the set of user controls via the receiver module 302.

Where the enterprise application platform 112 generates the one or more metadata elements of “create”, for example, the enterprise application platform 112 may generate metadata elements indicative of a screen set of a create or add operation, a detail screen for the create or add operation, a button to open the screen for the create or add operation, a create or add action associated with a button, a transaction step for the create or add action, and an apply step for the create or add action. The screen for the create action may further include one or more data input fields and a create button for the create or add action.

The one or more metadata elements indicative of the button to open the screen of the create or add operation may generate a graphical representation of a button in a graphical user interface to open, instantiate, or otherwise begin the create or add action. Although discussed as a button, it will be understood by one skilled in the art that the metadata elements may be indicative of an interactive graphical user interface element other than a button. For example, the metadata element may be indicative of a gesture on a touch-screen (e.g., a tap, a swipe, a pinch, etc.), a dial, or any other interactive element capable of receiving an indication from a user indicative of a desire to open the screen of the create or add operation. The one or more metadata elements indicative of the screen set of the create or add operation and the detail screen for the create or add operation may be graphical representations, for display in a graphical user interface, of images for display when the user has selected the create or add operation in the application, which includes the one or more metadata elements.

Where the enterprise application platform 112 generates the one or more metadata elements of “read,” for example, the enterprise application platform 112 may generate metadata elements indicative of a screen set of a detail operation. The enterprise application platform 112 may also generate a button to open the screen of the read or detail operation, a read or detail action associated with a button, and a navigation step for the read or detail action. The read or detail action may employ or be indicative of a fetch operation to read data from the selected data source.

The one or more metadata elements indicative of the button to open the screen of the read or detail operation may generate a graphical representation of a button in a graphical user interface to open, instantiate, or otherwise begin the read or detail action. Although discussed as a button, it will be understood by one skilled in the art that the one or more metadata element may be indicative of an interactive graphical user interface element other than a button. For example, the metadata element may be indicative of a gesture (e.g., a tap, a swipe, a pinch, etc.), a dial, or any other interactive element capable of receiving an indication from a user indicative of a desire to open the screen of the read or detail operation. The one or more metadata elements can be indicative of the screen set of the read or detail operation may be a graphical representation of images for display in a graphical user interface when the user has selected the read or detail operation in the application, which includes the one or more metadata elements.

The navigation step for the read or detail action may cooperate to locate and retrieve data specified, identified, queried, or otherwise requested by the user from the data source. In some example embodiments, the data retrieved from the data source may be displayed on a device by the one or more metadata elements associated with the read or detail action, or by another metadata element or segment of the application.

Similar to the create or add action, where the enterprise application platform 112 generates the one or more metadata element of “update”, the enterprise application platform 112 may generate metadata elements indicative of a screen set for the update or edit operation. The enterprise application platform 112 can also generate a detail screen for the update or edit operation, a button to open the screen for the update or edit operation, a transaction step for the update or edit operation, and an apply step for the update or edit operation.

The one or more metadata elements indicative of the button to open the screen of the update or edit operation may generate a graphical representation of a button in a graphical user interface to open, instantiate, or otherwise begin the update or edit action. Although discussed as a button, it will be understood by one skilled in the art that the one or more metadata element may be indicative of an interactive graphical user interface element other than a button. For example, the metadata element may be indicative of a gesture (e.g., a tap, a swipe, a pinch, etc.), a dial, or any other interactive element capable of receiving an indication from a user indicative of a desire to open the screen of the update or edit operation. The one or more metadata elements indicative of the screen set of the update or edit operation and the detail screen for the update or edit operation may be graphical representations of images and interactive user interface elements for display in a graphical user interface when the user has selected the update or edit operation in the application, which includes the one or more metadata elements.

Where the enterprise application platform 112 generates the one or more metadata elements of “delete”, for example, the enterprise application platform 112 may generate metadata elements indicative of a screen of a delete operation, a confirmation screen for the delete operation, a button to start the delete operation, a delete action associated with a button, a transaction step for the delete action, and an apply step for the delete action. In some example embodiments, the one or more metadata element for the delete action may further include a delete button for the delete action. The confirmation screen can provide a user prompt for confirming if the deletion is expected or not.

The one or more metadata elements indicative of the button to start the delete operation may generate a graphical representation of a button in a graphical user interface to delete or otherwise remove from displayed data selected from the data source. Although discussed as a button, it will be understood by one skilled in the art that the one or more metadata element may be indicative of an interactive graphical user interface element other than a button. For example, the metadata element may be indicative of a gesture (e.g., a tap, a swipe, a pinch, etc.), a dial, or any other interactive element capable of receiving an indication from a user indicative of a desire to start delete operation.

The one or more metadata elements indicative of the screen set of the delete operation and the detail screen for the delete operation may be graphical representations of images and interactive elements for display in a graphical user interface of the application when the user has selected the delete operation in the application, which includes the one or more metadata elements.

The method 400 may additionally include operation 454, in which, the enterprise application platform 112 receives one or more selections of a set of user interface options. For example, the receiver module 302 of the enterprise application platform 112 may receive the user interface option selection. The user interface option may include formatting options for the screens of the graphical user interface relating to the display of the one or more metadata elements and the one or more selected user controls. In some example embodiments, the user interface option may additionally include selected user interface options associated with the selected platform or the selected data source. The enterprise application platform 112 can receive the selection of the set of user interface options via the receiver module 302.

The operation 450 may further include operation 456, whereby the enterprise application platform 112 may create relationships between properties of the selected data objects in the data source and the selected interactive object in the application. For example, the receiver module 302, in response to the data source selection, may create the relationships between the data object in data source and the interactive object. The one or more elements may include a source property to the target property. The enterprise application platform 112 may perform operation 458 to generate response mappings between the data retrieved from the data source and the interactive object. In some example embodiments, the mapping module 308 can create relationships between properties of selected data objects in the data source and the selected interactive object in the application.

In operation 460, the enterprise application platform 112 generates one or more metadata elements defining interactions with the selected data object of the selected data source and the business object in the application. The element generation module 304 of the enterprise application platform 112 may generate the one or more metadata elements, in some embodiments. For example, the element generation module 304 can generate metadata elements indicative of the create, read, update, and delete operations described above. The enterprise application platform 112 may generate the one or more metadata elements based on a predetermined set of rules. The enterprise application platform 112 may determine which of the predetermined sets of rules to apply in generating the metadata elements based on the selected data source, data object, properties, operations, platforms, and screens, received in operations 410, 420, 430, 440, and 450 respectively. The generation module 310 or the element generation module 304 can generate the one or more metadata elements.

In some example embodiments, such as where the selected data source is an OData service, the enterprise application platform 112 may additionally generate Uniform Resource Locators (URLs) and authentication headers of Hypertext Transfer Protocol (HTTP) requests and payloads following the OData specification. The enterprise application platform 112 can also create XPath as well as HTTP response mappings that map Extensible Markup Language (XML) data returned from the OData service to business object properties.

Where the enterprise application platform 112 has received the one or more selections of a user control configured to enable the user to interact with the data object in operation 452, the element generation module 304 of the enterprise application platform 112 may then perform operation 462 and generate one or more metadata elements corresponding to the one or more selected user controls.

Where the enterprise application platform 112 has received one or more selections of the user interface options in operation 454, the element generation module 304 of the enterprise application platform 112 can perform operation 464 and generate one or more metadata elements corresponding to the one or more selected user interface options. For example, the one or more metadata elements may control the display of interactive elements, screens, and other aspects of an application compiled from the one or more metadata elements discussed above in relation to the data object, the data source, or the platform.

Where the enterprise application platform 112 has created the relationships between the one or more elements of the selected data object and the business object, in operation 456, the element generation module 304 of the enterprise application platform 112 may generate one or more metadata elements corresponding to the relationships in operation 458.

In operation 470, the enterprise application platform 112 may generate an application from the one or more metadata elements and the client application (e.g., shell application). In some embodiments, in operation 470, the enterprise application platform 112 may define an order for the one or more metadata elements within the application, or a metadata definition file associated the application, such that the one or more metadata elements cooperate together to enable the application to perform at least the functions described above. As referenced above, the application generation module 306 may receive the one or more metadata elements generated by the element generation module 304 and generate an application that can operate on the platforms and interact with the data source and data object, in an order specified in operation 470. In some example embodiments, the generation module 310 or the application generation module 306 can generate the application from a combination of the one or more metadata elements and the client application. Once the application has been generated in operation 470, the enterprise application platform 112 may deploy the application to a mobile platform server to enable execution in client interfaces on the one or more platforms supported by the enterprise application platform 112.

In some example embodiments, the application will be loaded by a shell application, described above, developed prior to the generation of the one or more metadata elements. The enterprise application platform 112 can store the metadata elements, for example in a metadata application file or a metadata definition file, accessible by the shell application. The enterprise application platform 112 or the client device can run or otherwise execute the processor executable instructions of the shell application to load and interpret the one or more metadata elements and thereby execute instructions defined by those metadata elements. The shell application, interpreting the definitions of the metadata elements can act as a complete, meaningful, and working application capable of reading and displaying data of a business object (e.g., a purchase order) from a data source. The shell application, interpreting the definitions of the metadata elements, can at least perform create, update, and delete operations for the business object against the data source.

The method 400 can include a set of preliminary operations prior to the commencement of the method 400. For example, in operation 402, the enterprise application platform 112 may determine whether a current project is available and whether a module is available. In some example embodiments, where the enterprise application platform 112 is an AGENTRY platform (available from SAP SMP), the project may be an AGENTRY project.

The method 400 may additionally determine, in operation 404, if one or more data source connections are available, prior to the inception of operation 410. If no data source connection is available, the enterprise application platform 112 may display or otherwise transmit a warning to the user and enable the user to input or otherwise initiate a data source connection prior to proceeding with the operations of the method 400.

If the enterprise application platform 112 determines that no current project or no module is available, the enterprise application platform 112 can create a current project and/or module, in operation 406. After determining that both the current project and the module are created and available, and data source connections are available, the method 400 may progress to the operation 410.

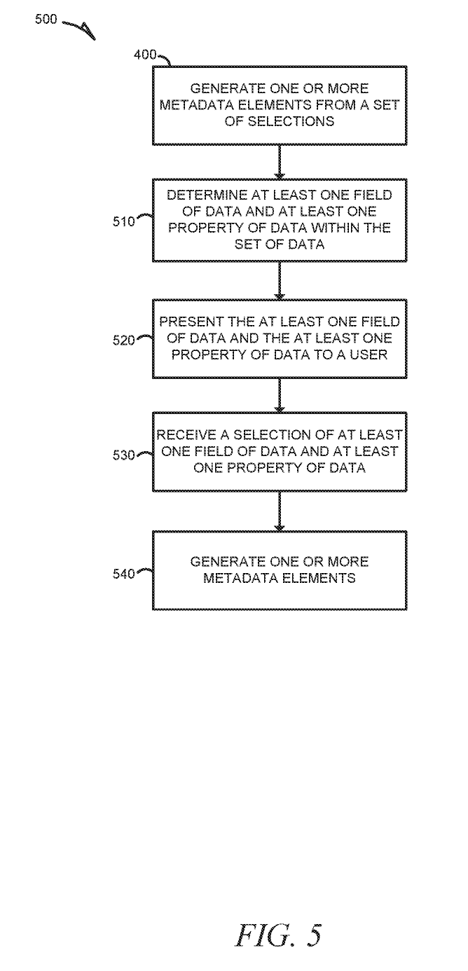

FIG. 5 shows a flow chart illustrating a method 500, according to an example embodiment, of generating one or more metadata elements, from a set of selections, for an application. The method 500 may comprise operations 410, 420, 430, 440, 450, 460, and 470 of the method 400, and additionally comprise operations 510, 520, 530, and 540. Although operations of the method 500 may be performed on the enterprise application platform 112, the client machine 116, the client/server machine 117, a mobile device, or combinations thereof, for the sake of clarity, the method 500 will be described with reference to the enterprise application platform 112.

In operation 510, the enterprise application platform 112 determines at least one field of data and at least one property of data for the selected data object within the set of data objects of the data source. The element generation module 304 can determine the at least one field of data and the at least one property of data based on one or more predetermined field of data and one or more predetermined property of data associated with the selected data object. The one or more predetermined field of data and the one or more predetermined property of data can be associated with the selected data object by the enterprise application platform 112 or by the user. For example, the receiver module 302 can present the user with selection options corresponding to the predetermined field of data and the predetermined property of data, where certain of the predetermined fields of data and certain of the predetermined properties of data have been previously associated with the selected data object. In some example embodiments, the user can select at least one of the predetermined fields of data and at least one of the predetermined properties of data from the presented selection options.

Each of the predetermined field of data can be associated with a data type. The data type the fields of data may be associated with a data structure, a program, a data source, or the like. For instance, the data type can be a source type corresponding to a data type employed by the data source or an application type corresponding to a data type employed by a predetermined program or platform (e.g., AGENTRY). The property of data can be associated with the field of data or the data type associated with the field of data. For example, where a string type is the data type, the property of data can be selected from a group including a maximum length, a minimum length, or a default value of data. Where the data type is an integer number type, the property of data can be selected from a group including a maximal value, a minimal value, and a default value. Further, in some example embodiments, the property of data can include designations for the field of data or the data property. For instance, where the field includes a display name, the user may select or otherwise edit the display name to reflect a chosen designation for the field of data, the data type, or one or more of the properties of data. It will be understood that the property of data can include one or more property suitable for the data type or the selected field of data.

In operation 520, the enterprise application platform 112 presents the at least one data object, the at least one field of data, and the at least one property of data to the user. To perform the operation 520, the enterprise application platform 112 can generate a screen with interactive elements enabling selection of one data object, the at least one field of data, and at least one property of data to the user. In some example embodiments, the presentation module 314 can cause presentation of the at least one data object, the at least one field of data, and the at least one property of data to the user on a user interface of the enterprise application platform 112.

In operation 530, the enterprise application platform 112 receives a selection of at least one data object, the at least one field of data, and the at least one property of data. The selection may be received by the user interacting with the interactive elements, entry of information into a data entry field, or any other suitable method. The receiver module 302 can receive the selection of the at least one data object and the at least one field of the object.

In operation 540, the enterprise application platform 112 generates one or more metadata elements corresponding to the selected one data object, fields of data, and property of data. In some example embodiments, the generation module 310 or the element generation module 304 can generate the one or more metadata elements.

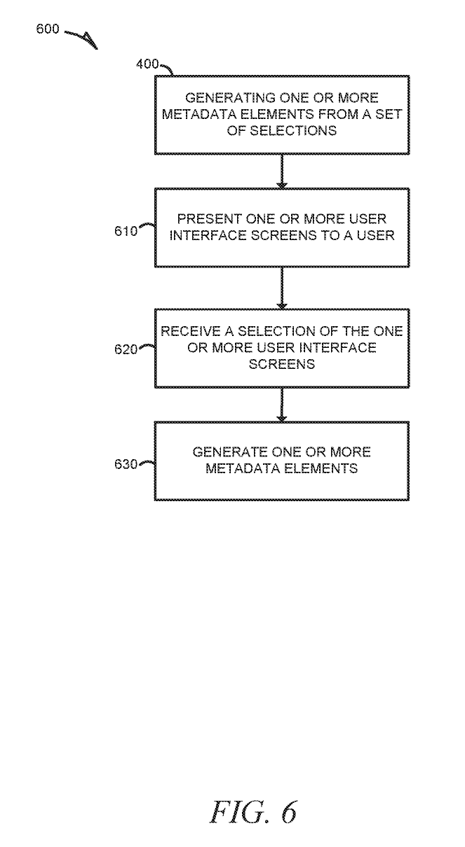

FIG. 6 shows a flow chart illustrating a method 600, according to an example embodiment, of generating one or more metadata elements, from a set of selections. The method 600 may comprise operations 410, 420, 430, 440, and 450 of the method 400, and operations 610, 620, and 630. Although operations of the method 600 may be performed on the enterprise application platform 112, the client machine 116, the client/server machine 117, a mobile device, or combinations thereof, for the sake of clarity, the method 600 will be described with reference to the enterprise application platform 112.

In operation 610, the enterprise application platform 112 presents one or more user interface screens to the user. The enterprise application platform 112 can generate metadata elements based on user selections and one or more templates, abstracting one kind of application with predetermined or customizable screens, layouts, operational capabilities, control flows, and business logics. The template can be tuned by configuring its properties within the enterprise application platform.

In operation 620, the enterprise application platform 112 receives a selection of the one or more user interface screens. The enterprise application platform 112 can receive the selection based on a user selection of an interactive element. In some example embodiments, the enterprise application platform 112 may determine one or more of the user interface screens based on the template selected by the user or based on cooperating functions of the one or more user interface screen. The receiver module 302 can receive the selection of the one or more user interface screens.

In operation 630, the enterprise application platform 112 generates one or more metadata elements corresponding to the selected one or more user interface screens. The element generation module 304 can generate the one or more metadata elements.

### Example Mobile Device

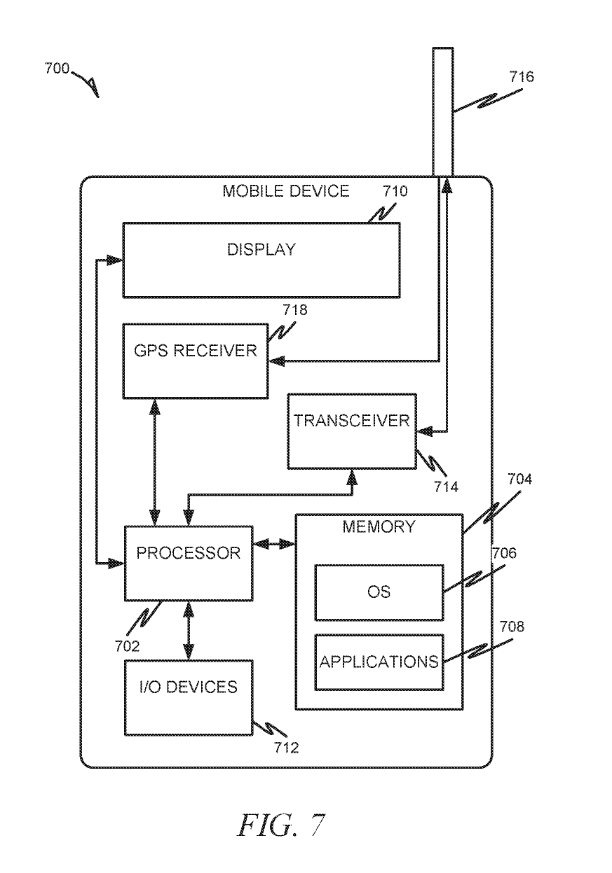

FIG. 7 is a block diagram illustrating a mobile device 700, according to an example embodiment. The mobile device 700 can include a processor 702. The processor 702 can be any of a variety of different types of commercially available processors suitable for mobile devices 700 (for example, an XScale architecture microprocessor, a Microprocessor without Interlocked Pipeline Stages (MIPS) architecture processor, or another type of processor). A non-transitory machine-readable storage medium 704, such as a memory, a random access memory (RAM), a Flash memory, or other type of memory, is typically accessible to the processor 702. The non-transitory machine-readable storage medium 704 can be adapted to store an operating system (OS) 706, as well as application programs 708, such as a mobile location enabled application that can provide LBSs to a user. The processor 702 can be coupled, either directly or via appropriate intermediary hardware, to a display 710 and to one or more input/output (I/O) devices 712, such as a keypad, a touch panel sensor, a microphone, and the like. Similarly, in some embodiments, the processor 702 can be coupled to a transceiver 714 that interfaces with an antenna 716. The transceiver 714 can be configured to both transmit and receive cellular network signals, wireless data signals, or other types of signals via the antenna 716, depending on the nature of the mobile device 700. Further, in some configurations, a Global Positioning System (GPS) receiver 718 can also make use of the antenna 716 to receive GPS signals.

### Modules, Components and Logic

Certain embodiments are described herein as including logic or a number of components, modules, or mechanisms. Modules can constitute either software modules (e.g., code embodied on a machine-readable medium or in a transmission signal) or hardware modules. A hardware module is a tangible unit capable of performing certain operations and can be configured or arranged in a certain manner. In example embodiments, one or more computer systems (e.g., a standalone, client, or server computer system) or one or more hardware modules of a computer system (e.g., a processor or a group of processors) can be configured by software (e.g., an application or application portion) as a hardware module that operates to perform certain operations as described herein.

In various embodiments, a hardware module can be implemented mechanically or electronically. For example, a hardware module can comprise dedicated circuitry or logic that is permanently configured (e.g., as a special-purpose processor, such as a field programmable gate array (FPGA) or an application-specific integrated circuit (ASIC)) to perform certain operations. A hardware module can also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) can be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor can be configured as respective different hardware modules at different times. Software can accordingly configure a processor, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple of such hardware modules exist contemporaneously, communications can be achieved through signal transmission (e.g., over appropriate circuits and buses) that connect the hardware modules. In embodiments in which multiple hardware modules are configured or instantiated at different times, communications between such hardware modules can be achieved, for example, through the storage and retrieval of information in memory structures to which the multiple hardware modules have access. For example, one hardware module can perform an operation and store the output of that operation in a memory device to which it is communicatively coupled. A further hardware module can then, at a later time, access the memory device to retrieve and process the stored output. Hardware modules can also initiate communications with input or output devices and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors can constitute processor-implemented modules that operate to perform one or more operations or functions. The modules referred to herein can, in some example embodiments, comprise processor-implemented modules.

Similarly, the methods described herein can be at least partially processor-implemented. For example, at least some of the operations of a method can be performed by one or more processors or processor-implemented modules. The performance of certain of the operations can be distributed among the one or more processors, not only residing within a single machine, but deployed across a number of machines. In some example embodiments, the processor or processors can be located in a single location (e.g., within a home environment, an office environment or as a server farm), while in other embodiments the processors can be distributed across a number of locations.

The one or more processors can also operate to support performance of the relevant operations in a “cloud computing” environment or as a “software as a service” (SaaS). For example, at least some of the operations can be performed by a group of computers (as examples of machines including processors), these operations being accessible via a network (e.g., the network 114 of FIG. 1) and via one or more appropriate interfaces (e.g., APIs).

Example embodiments can be implemented in digital electronic circuitry, or in computer hardware, firmware, software, or in combinations of them. Example embodiments can be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations can be performed by one or more programmable processors executing a computer program to perform functions by operating on input data and generating output. Method operations can also be performed by, and apparatus of example embodiments can be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware can be a design choice. Below are set out hardware (e.g., machine) and software architectures that can be deployed, in various example embodiments.

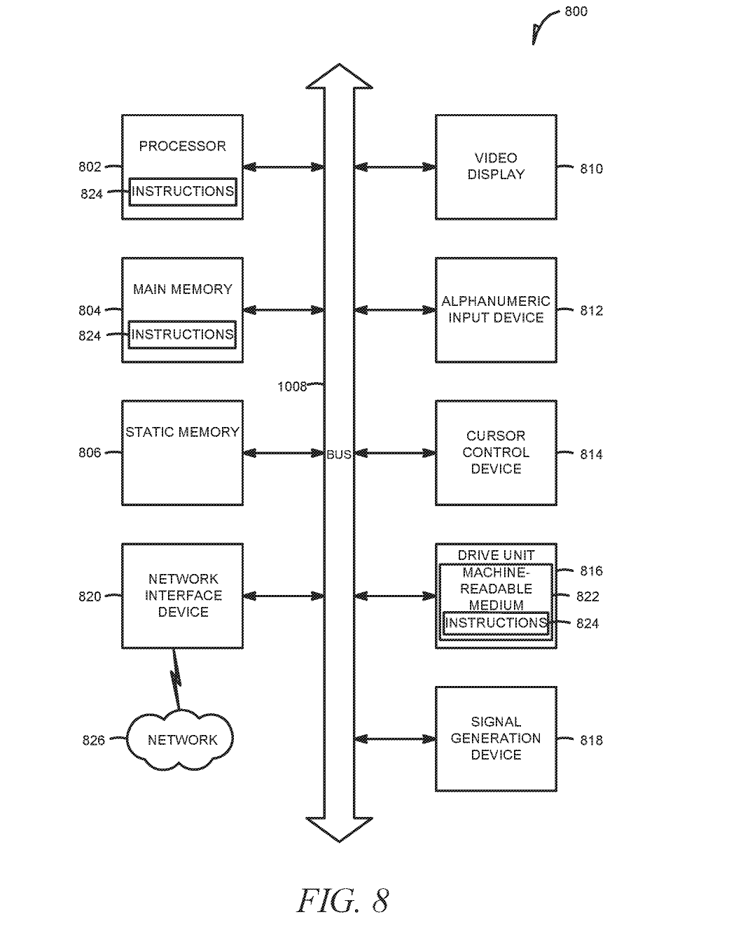

FIG. 8 is a block diagram of a machine in the example form of a computer system 800 within which instructions 824 for causing the machine to perform any one or more of the methodologies discussed herein can be executed, in accordance with an example embodiment. In alternative embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU), or both), a main memory 804 and a static memory 806, which communicate with each other via a bus 808. The main memory 804 and the static memory 806 may be implemented as non-transitory machine-readable storage mediums. The computer system 800 can further include a video display unit 810 (e.g., a liquid crystal display (LCD) or a cathode ray tube (CRT)). The computer system 800 also includes an alphanumeric input device 812 (e.g., a keyboard), a user interface (UI) navigation (or cursor control) device 814 (e.g., a mouse), a disk drive unit 816, a signal generation device 818 (e.g., a speaker), and a network interface device 820.

The disk drive unit 816 includes a machine-readable medium 822 on which is stored one or more sets of data structures and instructions 824 (e.g., software) embodying or utilized by any one or more of the methodologies or functions described herein. The instructions 824 can also reside, completely or at least partially, within the main memory 804 and/or within the processor 802 during execution thereof by the computer system 800, with the main memory 804 and the processor 802 also constituting machine-readable media. The instructions 824 can also reside, completely or at least partially, within the static memory 806.

While the machine-readable medium 822 is shown in an example embodiment to be a single medium, the term “machine-readable medium” can include a single medium or multiple media (e.g., a centralized or distributed database, and/or associated caches and servers) that store the one or more instructions 824 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

The instructions 824 can further be transmitted or received over a communications network 826 using a transmission medium. The instructions 824 can be transmitted using the network interface device 820 and any one of a number of well-known transfer protocols (e.g., HTTP). Examples of communication networks include a Local Area Network (LAN), a Wide Area Network (WAN), the Internet, mobile telephone networks, Plain Old Telephone Service (POTS) networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

Although an embodiment has been described with reference to specific example embodiments, it will be evident that various modifications and changes can be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter can be practiced. The embodiments illustrated are described in sufficient detail to enable those skilled in the art to practice the teachings disclosed herein. Other embodiments can be utilized and derived therefrom, such that structural and logical substitutions and changes can be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose can be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A computer-implemented method comprising:
receiving a selection of a data source from one or more data source connections, the data source having a set of data objects capable of being populated within the data source by a set of data, the set of data objects being representative of a set of interactive objects;
receiving a selection of a data object of the set of data objects to which data from the set of data is to be populated;
receiving selections of a set of operations to be performed on the data object;
receiving a selection of a platform through which the data object is accessed by the set of operations; and
generating, by a machine having a memory and at least one processor, one or more metadata elements defining interactions with the set of data and the data object for the data source and the interactive object through the platform based on the selection of the data source, the selection of the data object, the selections of the set of operations, and the selection of the platform.

2. The method of claim 1, wherein the platform comprises a computer system and a set of processor executable instructions stored in a non-transitory machine-readable storage medium of the computer system, the set of processor executable instructions comprising an operating system for the computer system.

3. The method of claim 1, wherein generating the one or more metadata elements further comprises:
defining an order for the one or more metadata elements.

4. The method of claim 1, further comprising:
receiving one or more selections of user controls configured to enable a user to interact with the data source and the object; and
generating one or more metadata elements corresponding to the one or more user controls.

5. The method of claim 1, further comprising:
receiving one or more selection of a user interface options; and
generating one or more metadata elements corresponding to the one or more user interface options.

6. The method of claim 1, further comprising:
creating relationship between one or more data elements of the data object and the interactive object; and
generating one or more metadata elements corresponding to the relationship between the one or more elements and the interactive object.

7. The method of claim 6, wherein the one or more data elements include a source type and an application type to map the one or more data elements to the interactive object.

8. The method of claim 1, further comprising:
determining, by the machine, at least one field of data and at least one property of data within the set of data.

9. The method of claim 8, further comprising:
causing presentation of the at least one field of data and the at least one property of data to a user;
receiving a selection of one or more of the at least one field of data and the at least one property of data; and
generating one or more metadata elements corresponding to the at least one field of data selected and at least one property of data selected.

10. The method of claim 1, further comprising:
causing presentation of one or more user interface screens to a user;
receiving a selection of the one or more user interface screens; and
generating one or more metadata elements corresponding to the one or more user interface screens selected.

11. The method of claim 1, further comprising:
generating response mappings between data retrieved from the set of data and the interactive object.

12. A system comprising:
a receiver module, comprising a hardware processor, configured to receive a selection of a data source from one or more data source connections, the data source having a set of data objects capable of being populated within the data source by a set of data and representative of a set of interactive objects, a selection of a data object of the set of data objects to which data from the set of data is to be populated, a selection of a set of operations to be performed on the data object, and a selection of a platform through which the data object is to be accessed by the set of operations; and
a generation module, comprising a hardware processor, configured to generate one or more metadata elements defining interactions with the data set for the data source and the interactive object through the platform based on the selection of the data source, the selection of the data object, the selections of the set of operations, and the selection of the platform.

13. The system of claim 12, wherein the generation module is further configured to define an order for the one or more metadata elements.

14. The system of claim 12, wherein the receiver module is further configured to receive one or more selections of user controls configured to enable a user to interact with the set of data of the data source and the interactive object and the generation module is further configured to generate one or more metadata elements corresponding to the one or more user controls.

15. The system of claim 12, wherein receiver module is further configured to receive one or more selections of a set of user interface options and wherein the generation module is further configured to generate one or more metadata elements corresponding to the one or more selections of the set of user interface options.

16. The system of claim 12 further comprising a mapping module configured to create a relationship between one or more data elements of the selected data object and the selected interactive object, and wherein the generation module is further configured to generate one or more metadata elements corresponding to the relationship between the one or more data elements and the selected interactive object.

17. The system of claim 16, wherein the one or more data elements includes a source type and an application type to map the one or more data elements to the interactive object.

18. The system of claim 12, wherein the generation module is further configured to determine at least one field of data and at least one property of data within the set of data.

19. The system of claim 18 further comprising a presentation module, comprising a hardware processor, configured to cause presentation of the at least one field of data and the at least one property of data to a user, wherein the receiver module is further configured to receive a selection of one or more of the at least one field of data and the at least one property of data, and the generation module is further configured to generate one or more metadata elements corresponding to the at least one field of data selected and the at least one property of data selected.

20. A non-transitory machine-readable storage medium, tangibly embodying a set of instructions that, when executed by at least one processor, causes the at least one processor to perform a set of operations comprising:
receiving a selection of a data source from one or more data source connections, the data source having a set of data objects capable of being populated within the data source by a set of data; the set of data objects being representative of a set of interactive objects;
receiving a selection of a data object of the set of data objects to which data from the data source is to be populated;
receiving selections of a set of operations to be performed on the data object;
receiving a selection of a platform through which the data object is accessed by the set of operations;
generating metadata elements defining interactions with the data set and the data object for the data source and the interactive object through the platform based on the selection of the data source, the selection of the data object, the selections of the set of operations, and the selection of the platform; and
generating an application from the one or more elements.
